(19) United States
(12) Patent Application Publication
(10) Pub. No.: US 2026/0307646 A1
(43) Pub. Date: Oct. 8, 2026

(54) GOLF VEHICLE WITH SWERVE DETECTION AND RESPONSE

(71) Applicant: Textron Inc., Providence, RI (US)

(72) Inventor: Lance Michael Fielder, McKinney, TX (US)

(73) Assignee: Textron Inc., Providence, RI (US)

(21) Appl. No.: 19/172,175

(22) Filed: Apr. 7, 2025

(51) Int. Cl. B60W 20/40; B60W 30/14; B60W 40/08; B60W 50/00; G06V 20/58

(52) U.S. Cl. CPC B60W 20/40; B60W 30/146; B60W 40/08; B60W 50/00; G06V 20/58; B60W 2040/0809; B60W 2050/0083; B60W 2300/405; B60W 2420/403; B60W 2520/10; B60W 2540/043; B60W 2540/18; B60W 2554/40; B60W 2556/40

(57) ABSTRACT

A golf vehicle includes a chassis, tractive elements, a driveline, a steering system, a sensor, and a controller. The tractive elements are coupled with the chassis. The driveline includes a prime mover configured to drive at least one of the tractive elements to transport the golf vehicle. The steering system is configured to turn a front pair of the tractive elements in response to a user input at a steering wheel. The sensor is configured to obtain sensor data indicating turning of the golf vehicle. The controller is configured to detect, based on the sensor data, if the golf vehicle has performed a swerve maneuver. The controller is further configured to, responsive to detecting that the golf vehicle has performed the swerve maneuver, adjust operation of the driveline.

### BACKGROUND

The present disclosure relates to control systems for recreational vehicles. More specifically, the present disclosure relates to vision systems for recreational vehicles.

### SUMMARY

One embodiment relates to a golf vehicle. The golf vehicle includes a chassis, tractive elements, a driveline, a steering system, a sensor, and a controller. The tractive elements are coupled with the chassis. The driveline includes a prime mover configured to drive at least one of the tractive elements to transport the golf vehicle. The steering system is configured to turn a front pair of the tractive elements in response to a user input at a steering wheel. The sensor is configured to obtain sensor data indicating turning of the golf vehicle. The controller is configured to detect, based on the sensor data, if the golf vehicle has performed a swerve maneuver. The controller is further configured to, responsive to detecting that the golf vehicle has performed the swerve maneuver, adjust operation of the driveline.

Another embodiment relates to a method of controlling a golf vehicle. The method includes obtaining, from a sensor, sensor data of surroundings of the golf vehicle, the sensor data indicating turning of the golf vehicle. The method includes detecting, based on the sensor data, if the golf vehicle has performed a swerve maneuver. The method also includes, in response to detecting that the golf vehicle has performed a swerve maneuver, adjusting operation of a driveline of the golf vehicle.

Still another embodiment relates to a control system for a recreational vehicle. The control system includes a camera and processing circuitry. The camera is configured to obtain image data of surroundings of the recreational vehicle indicating turning of the recreational vehicle. The processing circuitry is configured to determine, based on multiple frames of the image data, an angular velocity of the recreational vehicle. The processing circuitry is further configured to detect, based on the angular velocity, if the recreational vehicle has performed a swerve maneuver. The processing circuitry is also configured to at least one of adjust operation of a prime mover or engage a brake of the recreational vehicle to reduce a speed of the recreational vehicle responsive to detecting that the recreational vehicle has performed the swerve maneuver.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a perspective view of the vehicle of FIG. 1 including a swerve detection system, according to an exemplary embodiment.

FIG. 6 is a diagram of a swerve maneuver, according to an exemplary embodiment.

FIG. 7 is a block diagram of the swerve detection system of FIG. 5, according to an exemplary embodiment.

FIG. 8 is a flow diagram of a method for detecting a swerve maneuver on a recreational vehicle and operating a driveline responsive to detection of the swerve maneuver, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

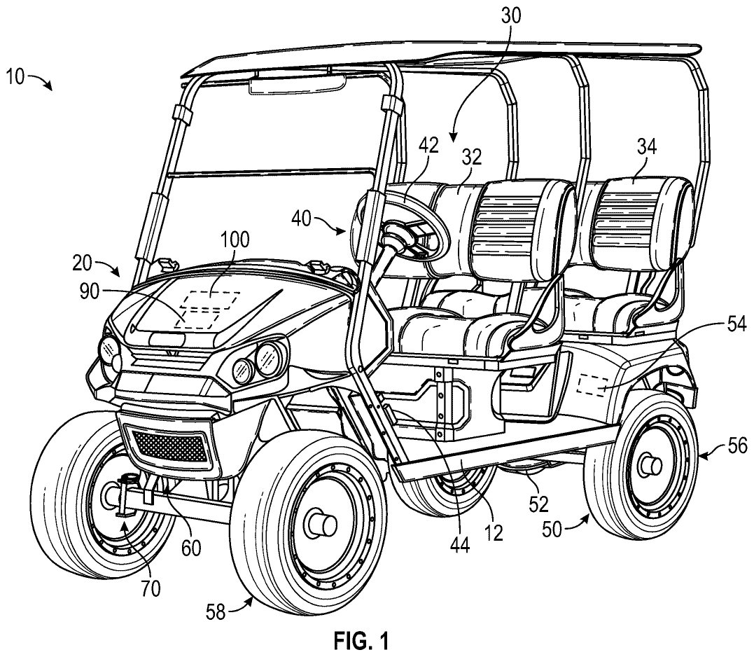

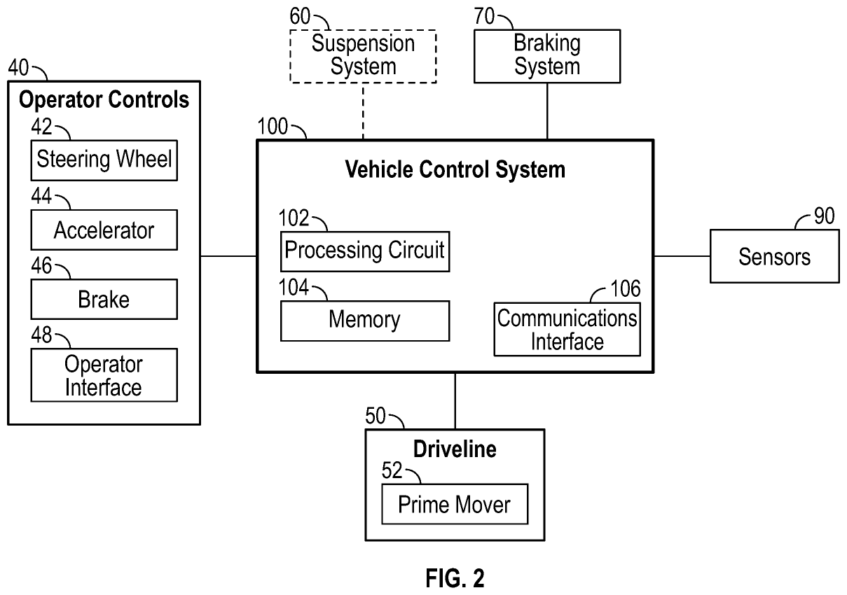

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle.

In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

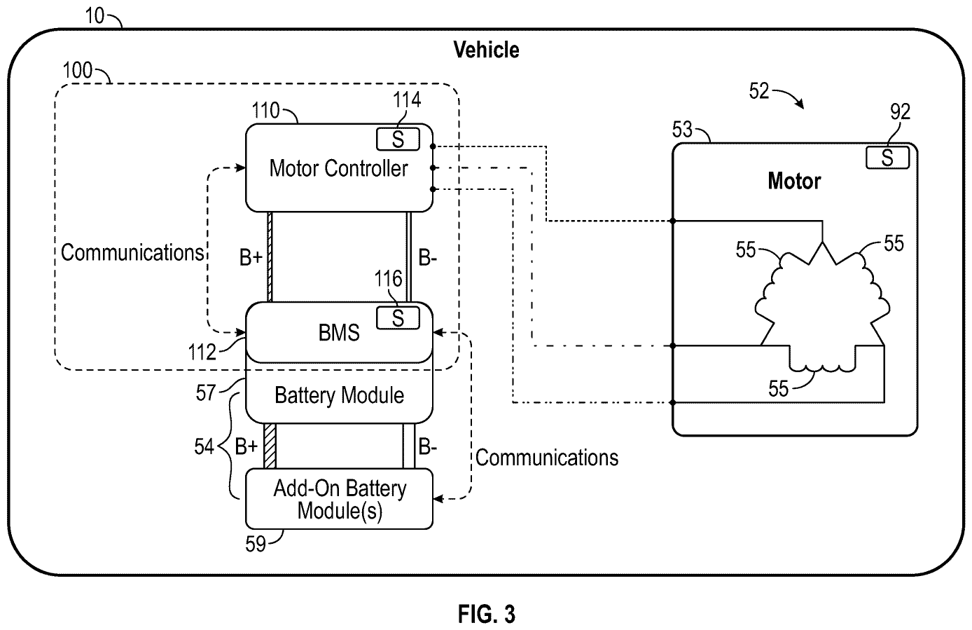

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

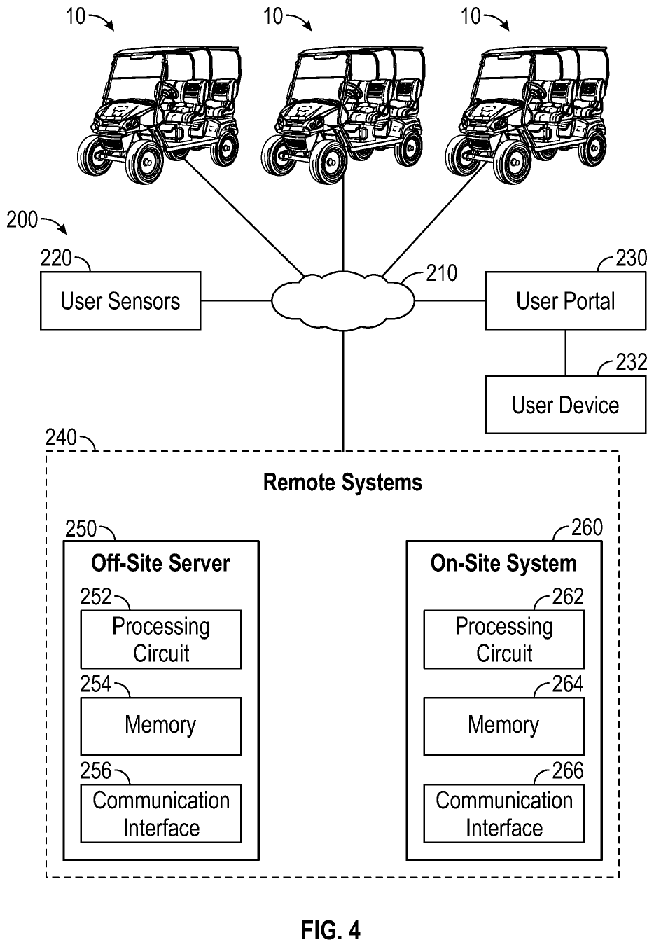

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Swerve Detection and Response

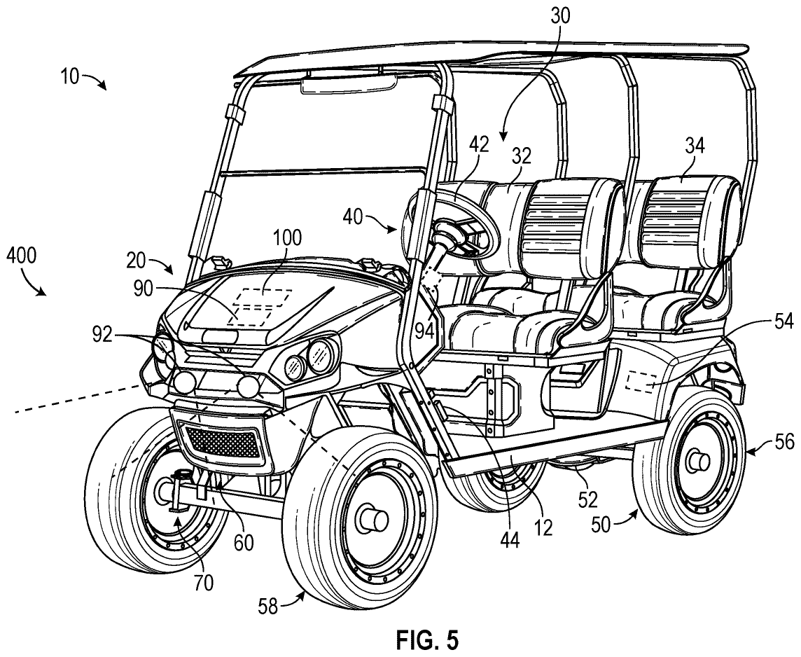

Referring to FIGS. 5-8, the vehicle 10 can be equipped with a control system 400 (e.g., a swerve detection system, a swerve detection and response system, etc.). The control system 400 is configured to detect a swerve event or maneuver of the vehicle 10. Recreational vehicles are sometimes “joy-ridden” by drivers which may involve swerving at a high rate of speed. Swerving at a high rate of speed can cause the recreational vehicle to roll and potentially even roll over. In order to mitigate the likelihood of a partial or complete rollover event due to swerving maneuvers, the control system 400 is configured to detect swerving maneuvers and perform a corrective action (e.g., reduce a speed of the vehicle 10, reduce a maximum allowed speed of the vehicle 10, decelerate the vehicle, etc.).

As shown in FIG. 5, the control system 400 can include one or more cameras 92. The cameras 92 are configured to obtain image data of surroundings of the vehicle 10 (e.g., a surrounding environment, objects in the environment, etc.). The cameras 92 can be provided on a front of the vehicle 10 as shown. For example, the cameras 92 can be provided on (e.g., coupled to) a front of the body 20 proximate to headlights. In some embodiments, the cameras 92 are positioned on a portion of the chassis 12. The cameras 92 can additionally or alternatively be disposed on opposite sides of the body 20 in order to obtain a wider field of view of the image data. In some embodiments, the control system 400 is configured to operate using a single camera or multiple cameras. Using multiple cameras 92 can provide a wider field of view of approximately 180 degrees. Using a single camera 92 can provide a field of view of 90 to 100 degrees. The control system 400 is configured to use the cameras 92 in order to determine a rate of change of a turn of the vehicle 10 (e.g., how frequently the vehicle 10 makes a turn or changes direction such as within a specific time period), and/or an angular velocity (e.g., speed of the vehicle 10 about a vertical axis or around a turn which may cause or indicate body roll of the vehicle 10, etc.) of the vehicle 10. The angular velocity can indicate lateral movement of the vehicle 10 (e.g., movement in a horizontal plane). The control system 400 can use the rate of change of the turn and/or the angular velocity of the vehicle 10 to detect the swerve maneuver in order to perform a corrective action (e.g., decreasing a speed of the vehicle 10). It should be understood that while the present application describes the user of cameras 92, the control system 400 can also use various radar or Light Detection and Ranging (LIDAR) sensors. However, the cameras 92 can advantageously provide a more cost-effective system.

In some embodiments, the control system 400 can include a steering sensor, shown as sensor 94. The sensor 94 is configured to obtain sensor data (e.g., rotation of the steering wheel 42) that otherwise indicates turning of the vehicle 10. For example, the sensor 94 can measure a position of the steering wheel 42. In some embodiments, the control system 400 is configured to determine rate of change of the steering wheel 42 or angular velocity by performing a numerical derivation analysis to time series data obtained from the sensor 94. It should be understood that the sensor 94 can be provided as a position sensor, a steering switch, etc., in order to directly or indirectly measure at least one of a position of the steering wheel 42 or a rate of change of the steering wheel 42. The control system 400 can additionally or alternatively use the sensor data provided by the sensor 94 in order to detect swerving maneuvers.

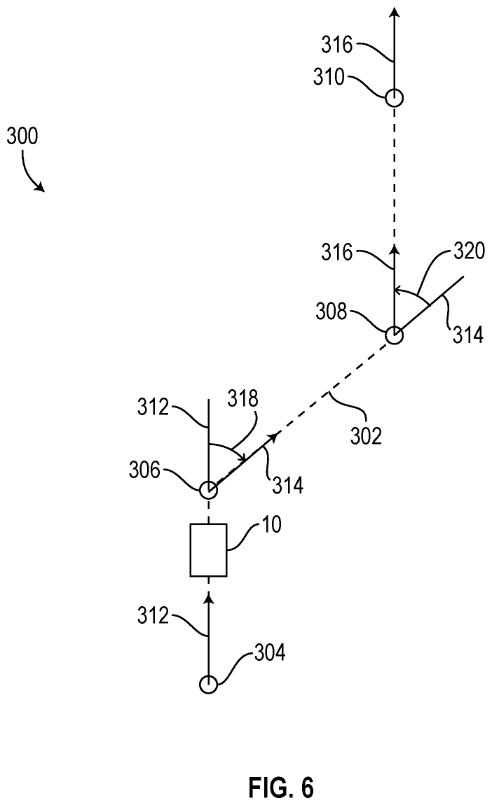

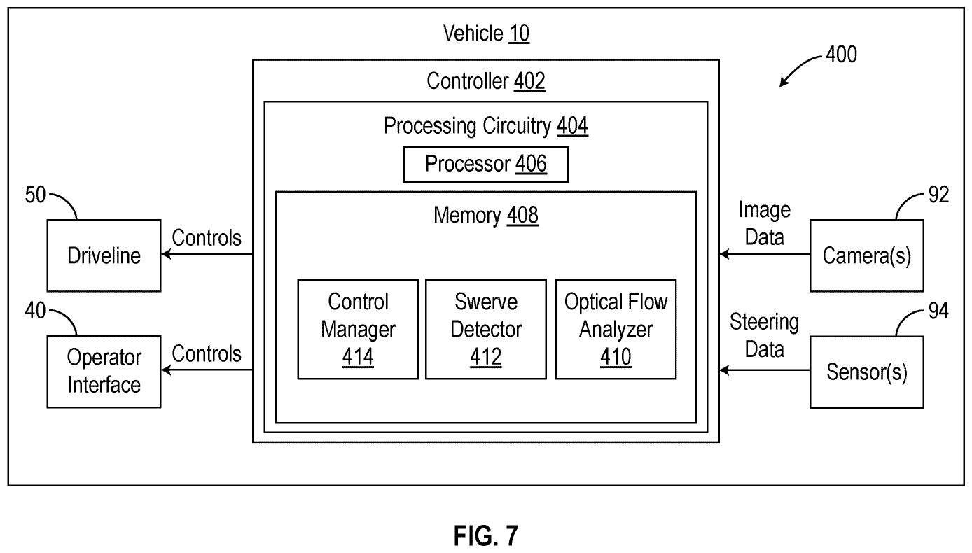

Referring to FIGS. 6 and 7, the control system 400 includes a controller 402, the cameras 92, and the sensors 94. The control system 400 can additionally include or otherwise be configured to communicate with the driveline 50 and/or the operator interface 40. In some embodiments, the controller 402 of the control system 400 is disposed locally on the vehicle 10. For example, the controller 402 can be substantially the same as otherwise similar to the vehicle control system 100. In some embodiments, one or more of the operations performed by the controller 402 (e.g., image analysis, corrective action determination, etc.) are performed by one or more remote systems such as the remote systems 240. Various parameters used by the controller 402 in order to detect the swerve maneuver can be updated or provided to the controller 402 by the remote systems 240. For example, a fleet manager may adjust tolerances or thresholds for their vehicles 10 in order to provide a more sensitive system that performs corrective actions (e.g., speed reduction) responsive to a desired threshold swerving (e.g., a system that is more sensitive than default settings). Likewise, a fleet manager can adjust the tolerates or thresholds for their vehicles 10 in order to change the corrective action that is performed (e.g., reporting which user is continually performing swerving maneuvers).

The controller 402 can use known characteristics of swerving maneuvers in order to detect if the vehicle 10 has performed a swerve. As shown in FIG. 6, a diagram 300 illustrates the characteristics of the swerving maneuver that the controller 402 can use to detect that the vehicle 10 has swerved. As shown in FIG. 6, the vehicle 10 is shown traveling along a path 302 that begins at a first point 304 and ends at a fourth point 310. As shown in the diagram 300, the vehicle 10 is traveling in a direction 312 from the first point 304 to a second point 306. At the second point 306, the vehicle 10 is turned an angular amount 318 such that the vehicle 10 travels in a direction 314. The vehicle 10 then travels from the second point 306 to a third point 308 at which point the vehicle 10 is turned an angular amount 320 (e.g., in an opposite direction as the angular amount 318 the vehicle 10 was turned previously) such that the vehicle 10 travels to the fourth point 310 in a direction 316. Accordingly, the controller 402 can detect a swerve maneuver performed by the vehicle 10 by determining angular velocity of the vehicle 10 along the second point 306 and along the third point 308. For example, if the vehicle 10 is turned multiple times in such a manner as to exceed a threshold angular velocity multiple times (e.g., twice) within a specific time period, the controller 402 can detect that the vehicle 10 has swerved. In some embodiments, the controller 402 is further configured to determine a rate at which the vehicle 10 is turned (e.g., a rate at which the vehicle 10 changes its orientation around the curves at the second point 306 and the third point 308) to determine if the vehicle 10 has swerved. In particular, the controller 402 can determine that the vehicle 10 has swerved if the angular velocity of the vehicle 10 exceeds a threshold and the vehicle 10 rapidly changes direction (e.g., a rate of change of direction of the vehicle 10 exceeds a threshold) twice or more within a predetermined time period (e.g., three seconds). In some embodiments, the controller 402 is also configured to determine a direction of the turns. For example, as shown in FIG. 6, the first turn at the point 306 is performed in a first direction, whereas the second turn at the point 308 is performed in a second direction. The controller 402 can use the directions in which the turn is performed in order to detect the swerve (e.g., the controller 402 may detect that a rapid or threshold change in a first direction followed by a rapid or threshold change in a second direction opposing the first direction indicates a swerve). In some embodiments, the threshold for the angular velocity is determined based on empirical testing from driving vehicles and recording an angular velocity that is associated with unacceptable roll of the vehicles. In some embodiments, the angular velocity is adjustable for a specific speed at which the vehicle 10 is currently traveling. For example, the controller 402 can obtain speed of the vehicle 10 from a speed sensor (e.g., the motor sensor 92) and use the speed of the vehicle 10 in order to determine if the vehicle 10 has performed a swerve maneuver.

Referring to FIG. 7, the controller 402 includes processing circuitry 404 including a processor 406 and memory 408. The processing circuitry 404 can be communicably connected with a communications interface of the controller 402 such that the processing circuitry 404 and the various components thereof can send and receive data via the communications interface. The processor 406 can be implemented as a general purpose processor, an application specific integrated circuit (ASIC), one or more field programmable gate arrays (FPGAs), a group of processing components, or other suitable electronic processing components.

The memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 408 can be or include volatile memory or non-volatile memory. The memory 408 can include database components, object code components, script components, or any other type of information structure for supporting the various activities and information structures described in the present application. According to some embodiments, the memory 408 is communicably connected to the processor 406 via the processing circuitry 404 and includes computer code for executing (e.g., by at least one of processing circuitry 404 or processor 406) one or more processes described herein.

The controller 402 can include an optical flow analyzer 410 that is configured to use frames of image data provided by the cameras 92 in order to detect various characteristics (e.g., the angular velocity of the vehicle 10, the rate of change of orientation or turning speed of the vehicle, etc.). The optical flow analyzer 410 can use frames of the image data to determine patterns of apparent motion of objects, surfaces, or edges in the environment of the vehicle 10. In particular, the optical flow analyzer 410 is configured to perform motion estimation to detect relative motion between the vehicle 10 and stationary objects such as trees, roadways, trails, bushes, landscape, etc. Movement of the stationary objects as determined by the optical flow analyzer 410 can indicate relative motion of the vehicle 10. In particular, the optical flow analyzer 410 determines the angular velocity of the vehicle 10 and provides the angular velocity to the swerve detector 412. The optical flow analyzer 410 can also determine, based on the optical flow analysis, the rate of turning of the vehicle 10 and a direction of turning of the vehicle 10. In some embodiments, the controller 402 and/or the optical flow analyzer 410 are configured to implement various pre-processing of the image data provided by the cameras 92. For example, the pre-processing can include implementing object detection in order to exclude any objects in the image data that may be moving on their own (e.g., not stationary) relative to the vehicle 10, and can therefore bias the calculation.

The optical flow analyzer 410 can use frames of the image data to perform the optical flow analysis. The optical flow analyzer 410 also uses a known framerate of the cameras 92 in order to determine amount of time of time that has elapsed between subsequent frames used for the optical flow analysis. For example, the optical flow analyzer 410 can determine an amount of motion of various stationary objects and use the amount of time that has elapsed between the frames used for the optical flow analysis to determine a speed or velocity of the stationary objects relative to the vehicle 10 and consequently to determine the angular velocity and/or rate of change of turning of the vehicle 10. In some embodiments, the optical flow analyzer 410 uses every frame provided by the cameras 92. In some embodiments, the optical flow analyzer 410 uses a subset of the frames provided by the cameras 92. For example, the optical flow analyzer 410 may use every third frame provided by the cameras 92 to determine the angular velocity and/or the rate of change of turning of the vehicle 10. In some embodiments, which frames the optical flow analyzer 410 uses (e.g., every frame, every second frame, every third frame, every fourth frame, etc.) can depend on the frame rate of the cameras 92. For example, if the cameras 92 have a low frame rate, the optical flow analyzer 410 can use every frame, whereas, if the cameras 92 have a high frame rate, the optical flow analyzer 410 can use every third frame. In some embodiments, which frames the optical flow analyzer 410 uses depends upon computational power of the processing circuitry 404 and/or the processor 406. Using every frame provided by the cameras 92 may provide higher accuracy in the determination of the characteristics of the vehicle 10 (e.g., the angular velocity, the direction of turning, the rate of change of turning, etc.) but decrease latency. Likewise, using every fourth frame or fifth frame can improve latency but may decrease accuracy in the determination of the characteristics of the vehicle 10.

In some embodiments, the controller 402 is configured to use steering data provided by the sensors 92 to determine the characteristics of the vehicle 10 for the swerve detection. The controller 402 can use the steering data to determine the angular velocity of the vehicle 10, the rate of turning of the vehicle 10, and the direction of turning of the vehicle 10. The steering data can be used in addition to or instead of the image data provided by the cameras 92. In some embodiments, the controller 402 is configured to use one or more integration or derivation techniques to determine, based on the steering data, the rate of turning of the vehicle. The controller 402 can also use predetermined relationships or equations to determine the angular velocity of the vehicle 10 based on the steering data.

The controller 402 also includes the swerve detector 412 that is configured to detect, based on results of analysis on the sensor data (e.g., the image data or the steering data) or based on the sensor data itself, if the vehicle 10 has performed a swerve. In some embodiments, the swerve detector 412 uses one or more threshold values for the angular velocity (e.g., threshold angular velocities) to determine if the vehicle 10 has performed a swerve maneuver. The swerve detector 412 can use a time period or time duration (e.g., three seconds, five seconds, etc.) across which the swerve detector 412 searches for whether the angular velocity of the vehicle 10 exceeds the one or more thresholds. In some embodiments, the swerve detector 412 is configured to determine if the angular velocity of the vehicle 10 exceeds the one or more thresholds at least twice over the time duration. For example, the angular velocity may increase and peak as the vehicle 10 performs a first turn over a first portion of the swerve maneuver and can increase and peak again as the vehicle 10 performs a second turn over a second portion of the swerve maneuver. In some embodiments, the swerve detector 412 is configured to detect the swerve maneuver in response to the angular velocity exceeding the one or more thresholds more than twice (e.g., three times or more over the time period or time duration).

The swerve detector 412 can also use the rate of change of turning or steering in order to detect if the vehicle 10 has performed the swerve maneuver. For example, the swerve detector 412 can use one or more thresholds for the rate of change in order to determine if the vehicle 10 has performed the swerve maneuver. In some embodiments, the swerve detector 412 is configured to determine that the vehicle 10 has performed the swerve maneuver in response to both the angular velocity of the vehicle 10 exceeding an angular velocity threshold and in response to the rate of change of turning or steering exceeding a corresponding turning threshold at least twice over the time period.

In some embodiments, the swerve detector 412 further uses the direction of turning of the vehicle 10 in order to detect whether the vehicle 10 has performed the swerve maneuver. In some embodiments, the swerve detector 412 detects the swerve maneuver in response (i) to the angular velocity of the vehicle 10 exceeding the angular velocity threshold, (ii) the rate of change of the turning or steering of the vehicle 10 exceeding the corresponding turning threshold at least twice over the time period (e.g., the vehicle 10 turning twice or more within the time period), and (iii) subsequent detections of turns performed by the vehicle 10 indicating that the vehicle 10 has been turned in a first direction and subsequently in a second direction.

In some embodiments, the swerve detector 412 is configured to use multiple thresholds for the angular velocity and/or the rate of turning of the vehicle 10. For example, the swerve detector 412 can include a first set of thresholds (e.g., alarm thresholds) that are lower than a second set of thresholds (e.g., remedial action thresholds). In some embodiments, exceeding the first set of thresholds indicates that the vehicle 10 has performed a maneuver that is approaching a swerve maneuver that will prompt remedial actions. The controller 402 can operate the operator interface 40 to provide an alarm to the driver (e.g., instructing the driver to slow down or avoid further swerves) if the angular velocity and/or the rate of change of the turning or steering exceeds the first set of thresholds a predetermined number of times over the time duration, but do not exceed the second set of thresholds. If the angular velocity and/or the rate of change of the turning exceeds the second set of thresholds at least the predetermined number of times over the time duration, the controller 402 can adjust operation of the driveline 50 to slow the vehicle to a predetermined speed (e.g., 10 miles per hour), or reduce a maximum allowable speed of the vehicle 10 (e.g., decelerate the vehicle 10 miles per hour and restrict the driver from driving at a speed over 10 miles per hour). In some embodiments, the driveline 50 is adjusted for a time period (e.g., for the next five minutes) such that the driver is restricted from exceeding the predetermined speed for the time period.

It should be understood that while the swerve detector 412 is described as being configured to detect swerve maneuvers, the swerve detector 412 can also be configured to detect other irregular maneuvers. For example, the swerve detector 412 can use the results of the optical flow analyzer 410 or the sensor data (e.g., the image data, the steering data, etc.) to detect other maneuvers such as turning too sharply at a high speed, making irregular turns, making jerky turns, etc. In more general terms, the swerve detector 412 is configured to use characteristics of steering or driving operations of the vehicle 10 as indicated by the image data and extracted using the optical flow analyzer 410 (and/or using other sensor data such as steering data) to determine if a specific type of maneuver has been performed and adjustments to the driveline 50 in order to reduce a probability of a rollover event. Further, it should be understood that while the swerve detector 412 is described herein as using predetermined thresholds, any of the thresholds (e.g., parameters) described herein may be updated or adjusted such as responsive to updates from a cloud computing system, updates or adjustments from a fleet manager, or updates or adjustments from a neural network or artificial intelligence technique. In some embodiments, different types of maneuvers can prompt different corrective actions. For example, the controller 402 can adjust the driveline 50 to decrease rapidly to a slow speed in response to the swerve detector 412 determining that a quick swerve has been detected, whereas the controller 402 can adjust the driveline to decrease to a medium speed that is greater than the slow speed in response to the swerve detector 412 determining that a slower swerve has been detected. In this way, a magnitude of the swerve or characteristic of the swerve maneuver can be used to determine an appropriate adjustment to the driveline 50. The swerve detector 412 can also use a database of time-series data of angular velocities, rate of turning, direction of turning, etc., of various swerve maneuvers or types of restricted driving operations and perform a pattern matching analysis of time-series data obtained based on image data from the cameras 92 and/or steering data from the sensors 92 in order to determine if the vehicle 10 has performed a swerve maneuver and a type of swerve maneuver performed.

In some embodiments, the controller 402 is configured to use a database of various driving profiles in order to select one or more thresholds (e.g., the threshold angular velocity, threshold rate of turning, etc.) used to detect the swerve maneuver. For example, the various driving profiles can correspond to different driving skills or abilities and can include various values of the thresholds in order to adjust a sensitivity of swerve detection. For example, a “kids profile” may have stricter thresholds that result in a more sensitive detection of swerve maneuvers and thereby results in corrective action (e.g., speed reduction) more frequently than a normal profile. Likewise, an “expert” profile may have lower thresholds that result in a less sensitive detection of swerve maneuvers and thereby results in corrective actions less frequently. In some embodiments, the controller 402 is configured to query and retrieve an appropriate profile (and therefore threshold parameters for swerve detection) for a driver that is currently driving the vehicle 10 responsive to input of an identification, driving skill or experience, certifications, etc., provided via the operator interface 40, the remote systems 240, or the user device 232.

In some embodiments, the controller 402 is configured to retrieve, determine, or otherwise obtain values of the thresholds based on a current location of the vehicle 10. For example, the vehicle 10 may be able to transport along a map (e.g., a golf course, an approved area, trails, etc.) having known or expected paths, turns, etc. In some embodiments, the controller 402 is configured to obtain the map from the remote systems 240. For example, the map can be populated or generated by a user (e.g., a fleet manager) and provided to the vehicle 10 via communications network 210. In some embodiments, the map includes various areas or locations (e.g., portions of a trail, portions of the map, etc.) that are associated with various values of the thresholds. For example, different threshold parameters or values thereof to control the swerve maneuver can be tagged to the various areas. The areas can be defined by a user such as a fleet manager or owner of the property. In some embodiments, the threshold parameters are set by the user or automatically based on an expected turning or swerving maneuver in that area. In some embodiments, the threshold parameters are set based on an expected likelihood that a swerve maneuver will be performed in the area, or based on various characteristics of the area (e.g., terrain slope, elevation, blind spots, poor visibility, etc.) in order to reduce swerving or speed of the vehicle 10 through those areas or locations. The controller 402 can obtain the threshold parameters based on a current location of the vehicle 10. For example, as the vehicle 10 enters one of the areas on the map, the controller 402 can retrieve, from memory of the controller 402, or from the remote system 240, the associated threshold parameter. The controller 402 may use the associated threshold parameter as the vehicle 10 is transported through the area, and once entering a subsequent area may either default to a predetermined value of the threshold parameter or use a value of the threshold parameter for the subsequent area. The controller 402 may query a database for the associated threshold parameter or value thereof for use through the various areas, zones, or locations as the vehicle 10 approaches towards and travels through the various areas, zones, or locations.

The controller 402 also includes a control manager 414 that is configured to control the driveline 50 and/or the operator interface 40 by providing controls, respectively. In some embodiments, the control manager 414 is configured to operate the driveline 50 to limit a top speed of the vehicle 10 in response to detection of the swerve maneuver or a swerve event. In some embodiments, the control manager 414 is configured to operate the driveline 50 to decelerate the vehicle 10 to a predetermined speed (e.g., a reduced speed in order to mitigate rollover probability) in response to detection of the swerve maneuver. In some embodiments, the control manager 414 is configured to operate the driveline 50 subsequently such that the driver is prevented from driving over the top speed, even if the driver requests speed greater than the top speed. The control manager 414 can therefore control the driveline 50 responsive to the detection of the swerve maneuver by decelerating the vehicle to a reduced speed, and/or limiting a top speed of the vehicle 10. The control manager 414 can continue adjusting operation of the driveline 50 for a time period after detection of the swerve maneuver. In some embodiments, the time period can be set by a fleet manager via providing a user input such as from the user device 232 or the user portal 230. In some embodiments, the control manager 414 determines an appropriate control of the driveline 50 (e.g., the maximum allowable speed or speed to which the vehicle 10 should be reduced) based on the profile associated with the driver. In some embodiments, the control manager 414 is configured to decelerate the vehicle 10 by engaging (e.g., selectively) the brake 46.

The control manager 414 is also configured to operate the operator interface 40 to provide feedback to the driver regarding at least one of the detected swerve maneuver or the adjustment to the driveline 50. For example, the control manager 414 can operate a display screen or digital readout of the operator interface 40 to notify the driver that a swerve maneuver has been detected and that the vehicle 10 is being decelerated to, and limited to, 10 miles per hour top speed. In some embodiments, the control manager 414 is configured to provide other feedback to the user as supported by user-facing devices of the vehicle 10 such as haptic feedback, aural feedback, etc.

In some embodiments, any of the functionality for swerve detection described herein with reference to FIGS. 6-7 can be implemented as a node within a Robot Operating System (ROS) framework. For example, the node may subscribe to a “camera” topic in order to obtain the image data from the cameras 92 and can subscribe to a “slower” topic in order to implement the control of the driveline 50.

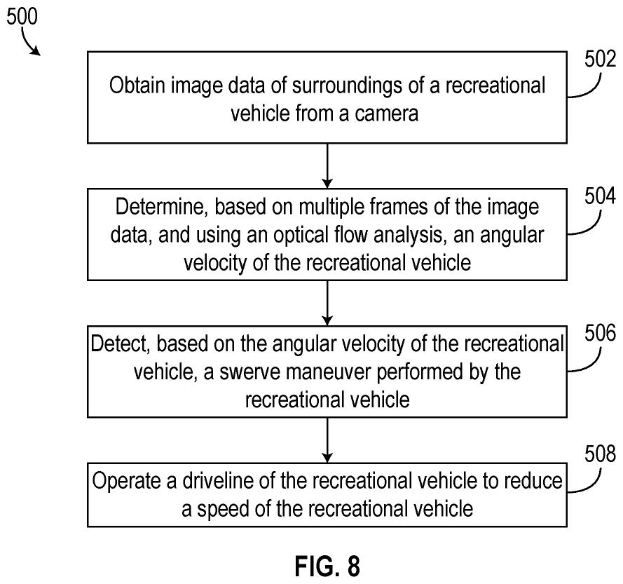

Referring to FIG. 8, a flow diagram of a method 500 for detecting whether a recreational vehicle has performed a swerve maneuver and performing a corrective or remedial action includes steps 502-508. The method 500 can be performed in order to limit improper driving by a driver (e.g., to reduce a likelihood of a rollover event). In some embodiments, the method 500 is performed by the control system 400 as described in greater detail above with reference to FIGS. 5-7.

The method 500 includes obtaining image data of surroundings of a recreational vehicle from a camera (step 502), according to some embodiments. The step 502 can include obtaining frames of the image data from a camera that is mounted to a front of the vehicle 10. In some embodiments, the step 502 is performed by receiving the image data from the cameras 92. In some embodiments, the step 502 includes obtaining sensor data from the steering sensors 94.

The method 500 also includes determining, based on multiple frames of the image data, and using an optical flow analysis, an angular velocity of the recreational vehicle (step 504), according to some embodiments. In some embodiments, the step 504 includes performing the optical flow analysis to determine relative motion of fixed objects in the environment (e.g., landscape objects). The relative motion or rate of change of the motion can indicate motion (e.g., turning, angular velocity, etc.) of the vehicle (e.g., the vehicle 10). In some embodiments, step 504 is performed by the optical flow analyzer 410 using any of the techniques described in greater detail above with reference to FIGS. 6-7. In some embodiments, the step 504 also includes determining a rate of change of turning or steering of the vehicle using the optical flow analysis.

The method 500 also includes detecting, based on the angular velocity of the recreational vehicle, a swerve maneuver performed by the recreational vehicle (step 506), according to some embodiments. In some embodiments, step 506 is performed by the swerve detector 412 using any of the techniques described in greater detail above with reference to FIGS. 6-7. The step 506 can also include using a rate of turning of the vehicle as determined in step 504 to detect the swerve maneuver. In some embodiments, step 506 includes determining if the angular velocity of the vehicle exceeds a threshold and if the rate of change of turning or steering of the vehicle exceeds a corresponding threshold at least twice over a predetermined time period.

The method 500 also includes operating a driveline of the recreational vehicle to reduce a speed of the recreational vehicle (step 508), according to some embodiments. In some embodiments, the step 508 is performed by the control manager 414 as described in greater detail above with reference to FIGS. 6-7. In some embodiments, step 508 includes adjusting the driveline 50 such that the vehicle 10 is decelerated to a threshold or predetermined speed. The step 508 is performed responsive to detecting the swerve maneuver in order to mitigate a likelihood of the vehicle 10 experiencing excessive body roll.

Advantageously, the systems and methods described herein can be implemented for swerve detection of a recreational vehicle in order to mitigate body roll of the vehicle. In some embodiments, the systems and methods can further be implemented for various other vehicles (e.g., snow mobiles, lawn mowers, all terrain vehicles, etc.) in order to detect swerve maneuvers, or to detect any maneuvers or operation of the recreational vehicle that deviates from desired driving operations. For example, the optical flow analysis can be implemented on a lawn mower to notify an operator regarding deviation from a straight line or to facilitate autonomous re-alignment of the lawn mower. Further, the optical flow analysis can be implemented in order to provide lane-assist such as to keep a recreational vehicle on a path or to reduce speed upon taking a curve along a path.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle comprising:
a chassis;
a plurality of tractive elements coupled with the chassis;
a driveline including a prime mover configured to drive at least one of the plurality of tractive elements to transport the golf vehicle;
a steering system configured to turn a front pair of the plurality of tractive elements in response to a user input at a steering wheel;
a sensor configured to obtain sensor data indicating turning of the golf vehicle; and
a controller configured to:
detect, based on the sensor data, if the golf vehicle has performed a swerve maneuver; and
responsive to detecting that the golf vehicle has performed the swerve maneuver, adjust operation of the driveline.

2. The golf vehicle of claim 1, wherein the sensor comprises a camera configured to obtain image data of surroundings of the golf vehicle, the controller configured to:
determine, based on a plurality of frames of image data from the camera, an angular velocity of the golf vehicle; and
detect if the golf vehicle has performed the swerve maneuver based on the angular velocity of the golf vehicle.

3. The golf vehicle of claim 2, wherein the controller is configured to detect that the golf vehicle has performed the swerve maneuver in response to the angular velocity of the golf vehicle being greater than an angular velocity threshold at least two times over a time period while the golf vehicle is traveling at or above a threshold speed.

4. The golf vehicle of claim 1, wherein the sensor comprises a camera, the camera coupled to a front of the golf vehicle and configured to obtain image data of surroundings of the golf vehicle indicating turning of the golf vehicle, and wherein the controller is configured to detect if the golf vehicle has performed the swerve maneuver using an optical flow analysis of a plurality of frames of the image data.

5. The golf vehicle of claim 1, wherein the sensor comprises a plurality of cameras, the plurality of cameras configured to obtain image data of surroundings of the golf vehicle indicating turning of the golf vehicle, and wherein the controller is configured to detect if the golf vehicle has performed the swerve maneuver using an optical flow analysis of a plurality of frames of the image data.

6. The golf vehicle of claim 1, wherein the controller is configured to operate the driveline to reduce an allowed speed of the golf vehicle in response to detecting that the golf vehicle has performed the swerve maneuver.

7. The golf vehicle of claim 1, wherein the sensor comprises a steering sensor coupled to the steering system, the steering sensor configured to monitor operation of the steering system as the sensor data, the controller configured to use the operation to detect if the golf vehicle has performed the swerve maneuver.

8. The golf vehicle of claim 1, wherein the controller is configured to use a threshold parameter to detect the swerve maneuver, the threshold parameter at least one of:
(i) selected by the controller from a plurality of threshold parameters each corresponding to one of a plurality of profiles that correspond to various levels of driving experience, wherein the controller selects the threshold parameter from the plurality of profiles based on an identity or driving experience of a driver of the golf vehicle; or
(ii) obtained by the controller based on a current location of the golf vehicle, wherein various locations in a map are associated with various threshold parameters configured to be used by the controller in order to reduce a speed of the golf vehicle for an expected swerve maneuver at the various locations in the map.

9. The golf vehicle of claim 1, wherein the sensor comprises a camera and the sensor data comprises image data, the controller configured to detect if the golf vehicle has performed the swerve maneuver based on detecting movement of stationary objects in a field of view of the image data.

10. A method of controlling a golf vehicle, the method comprising:
obtaining, from a sensor, sensor data of surroundings of the golf vehicle, the sensor data indicating turning of the golf vehicle;
detecting, based on the sensor data, if the golf vehicle has performed a swerve maneuver; and
in response to detecting that the golf vehicle has performed a swerve maneuver, adjusting operation of a driveline of the golf vehicle.

11. The method of claim 10, wherein the sensor comprises a camera configured to obtain image data of the surroundings of the golf vehicle, the method comprising:
determining, based on a plurality of frames of image data from the camera, an angular velocity of the golf vehicle; and
detecting if the golf vehicle has performed the swerve maneuver in response to the angular velocity being greater than an angular velocity threshold at least two times over a time period while the golf vehicle is traveling at or above a threshold speed.

12. The method of claim 10, wherein the sensor comprises a camera, the camera configured to obtain image data of the surroundings of the golf vehicle indicating turning of the golf vehicle, and wherein the method comprises detecting if the golf vehicle has performed the swerve maneuver using an optical flow analysis of a plurality of frames of the image data.

13. The method of claim 10, wherein the sensor comprises a plurality of cameras configured to obtain image data of surroundings of the golf vehicle indicating turning of the golf vehicle, the method comprising detecting if the golf vehicle has performed the swerve maneuver using an optical flow analysis of a plurality of frames of the image data.

14. The method of claim 10, wherein adjusting operation of the driveline comprises operating the driveline to reduce an allowed speed of the golf vehicle in response to detecting that the golf vehicle has performed the swerve maneuver.

15. The method of claim 10, wherein the sensor comprises a steering sensor configured to monitor operation of a steering system as the sensor data, wherein the operation is used to detect if the golf vehicle has performed the swerve maneuver.

16. A control system for a recreational vehicle, the control system comprising:
a camera configured to obtain image data of surroundings of the recreational vehicle indicating turning of the recreational vehicle; and
processing circuitry, configured to:
determine, based on a plurality of frames of the image data, an angular velocity of the recreational vehicle;
detect, based on the angular velocity, if the recreational vehicle has performed a swerve maneuver; and
responsive to detecting that the recreational vehicle has performed the swerve maneuver, at least one of adjust operation of a prime mover or engage a brake of the recreational vehicle to reduce a speed of the recreational vehicle.

17. The control system of claim 16, wherein the processing circuitry is configured to detect that the recreational vehicle has performed the swerve maneuver in response to the angular velocity of the recreational vehicle being greater than an angular velocity threshold at least two times over a time period while the recreational vehicle is traveling at or above a threshold speed.

18. The control system of claim 16, wherein the camera is a first camera, the control system further comprising a second camera, the processing circuitry configured to detect if the recreational vehicle has performed the swerve maneuver based on a plurality of frames of the image data obtained from both the first camera and the second camera.

19. The control system of claim 16, further comprising a steering sensor positioned to monitor operation of a steering system of the recreational vehicle, the processing circuitry configured to use the steering data acquired from the steering sensor in combination with the image data to detect if the recreational vehicle has performed the swerve maneuver.

20. The control system of claim 16, wherein the processing circuitry is configured to detect that the recreational vehicle has performed the swerve maneuver in response to detecting, based on the angular velocity, a first turn in a first direction and a second turn in a second direction opposing the first direction within a predetermined time period while the recreational vehicle is traveling at or above a threshold speed, and wherein the processing circuitry is configured to, in response to detecting that the recreational vehicle has performed the swerve maneuver, reduce a maximum allowable speed of the recreational vehicle.
